(19) United States
(12) Patent Application Publication
(10) Pub. No.: US 2019/0364151 A1
(43) Pub. Date: Nov. 28, 2019

(54) CALL DISTRIBUTION APPARATUS, CALL DISTRIBUTION METHOD, AND PROGRAM

(71) Applicants: Kabushiki Kaisha Toshiba, Minato-ku (JP); TOSHIBA INFRASTRUCTURE SYSTEMS & SOLUTIONS CORPORATION, Kawasaki-shi (JP)

(72) Inventor: Jun Kataoka, Kawasaki (JP)

(73) Assignees: Kabushiki Kaisha Toshiba, Minato-ku (JP); TOSHIBA INFRASTRUCTURE SYSTEMS & SOLUTIONS CORPORATION, Kawasaki-shi (JP)

(21) Appl. No.: 16/384,980

(22) Filed: Apr. 16, 2019

(30) Foreign Application Priority Data
May 24, 2018 (JP) 2018-099916

(51) Int. Cl. H04M 3/523; H04M 3/42; H04M 3/533

(52) U.S. Cl. CPC H04M 3/5238; H04M 3/5235; H04M 3/533; H04M 3/42221

(57) ABSTRACT

According to one embodiment, there is provided a call distribution apparatus performing a call distribution with respect to an operator including a storage unit, including an operation schedule database which stores an operation schedule of the operator and a calling time length database which stores a calling time length of the operator, and an operator determination unit which determines an operator to be assigned, based on the operation schedule and the calling time length.

### CROSS-REFERENCE TO RELATED APPLICATION

This application is based upon and claims the benefit of priority from Japanese Patent Application No. 2018-099916, filed May 24, 2018, the entire contents of which are incorporated herein by reference.

### FIELD

Embodiments of the present invention relate generally to a call distribution apparatus, a call distribution method, and a program.

### BACKGROUND

At a call center, in addition to a reception operation by a plurality of operators standing by and receiving commodity orders from customers, there is a transmission operation which involves the making of phone calls to customers for the purpose of commodity sales promotion.

In a call center system that manages a call center, a telephone exchange apparatus, generally referred to as PBX (Private Branch exchange) is installed. This telephone exchange apparatus has a function of establishing and maintaining a call line between a call center on an extension side and a telephone terminal on a customer side via a telephone public network.

As one function of the telephone exchange apparatus used for the operator's transmission operation at this call center, the telephone exchange apparatus automatically originates a call to a customer's call terminal, and if the customer responds, calls to an available operator to enable the operator to talk with this customer.

In recent call center systems, an operation schedule of each operator, such as a break time, can be registered in advance, and when a customer at a destination of an automatically-originated call responds, the transmission operation is assigned to an operator who is available on this operation schedule.

As described above, the call center system assigns the transmission operation to the available operator based on the operation schedule of each operator, but may bring about the following inconvenience.

For example, it is assumed that the call center system originates a call to a terminal of a customer at 11:55 a.m., and after the customer responds, the call center system refers to the schedule of each operator and assigns the transmission operation to an available operator.

However, there is a case where although the assigned operator is scheduled to enter a break period 5 minutes later at 12 a.m., the operator cannot enter the break period from 12 a.m. due to residual customer handling.

In this way, although the conventional call center system performs the call distribution for the operators in consideration of the operators' schedules, such inconvenience may be caused to the operators.

For this reason, it is desirable to provide a call distribution apparatus, a call distribution method, and a program capable of assigning a call operation, such as a transmission operation, without causing any inconvenience to the operators.

### BRIEF DESCRIPTION OF THE DRAWINGS

FIG. 1 is a diagram showing an overall configuration example of a call center system comprising a telephone exchange apparatus of an embodiment.

FIG. 2 is a block diagram showing a detailed configuration example of the telephone exchange apparatus and a priority database of the embodiment.

FIG. 3 is a flowchart showing an example of an operation (operator pre-distribution processing) by the telephone exchange apparatus of the embodiment.

FIG. 4 is a diagram showing an example of a priority order-setting database in which a priority order is updated via the operator pre-distribution processing by the telephone exchange apparatus of the embodiment.

FIG. 5 is a diagram showing an example of the operator-setting database in which a terminal ID connecting a line with a communication terminal is updated via the operator pre-distribution processing by the telephone exchange apparatus of the embodiment.

FIG. 6 is a flowchart showing an example of an operation (operator post-distribution processing) by the telephone exchange apparatus of the embodiment.

FIG. 7 is a diagram showing a connection destination response database storing an operator in charge of a call with a customer, who is fixed via the operator post distribution processing by the telephone exchange apparatus of the embodiment.

### DETAILED DESCRIPTION

An embodiment will be described with reference to the drawings. In the explanations below, the same components or portions are denoted by the same reference symbols throughout the drawings.

According to an embodiment, there is provided a call distribution apparatus performing a call distribution with respect to an operator including a storage unit, including an operation schedule database which stores an operation schedule of the operator and a calling time length database which stores a calling time length of the operator, and an operator determination unit which determines an operator to be assigned, based on the operation schedule and the calling time length.

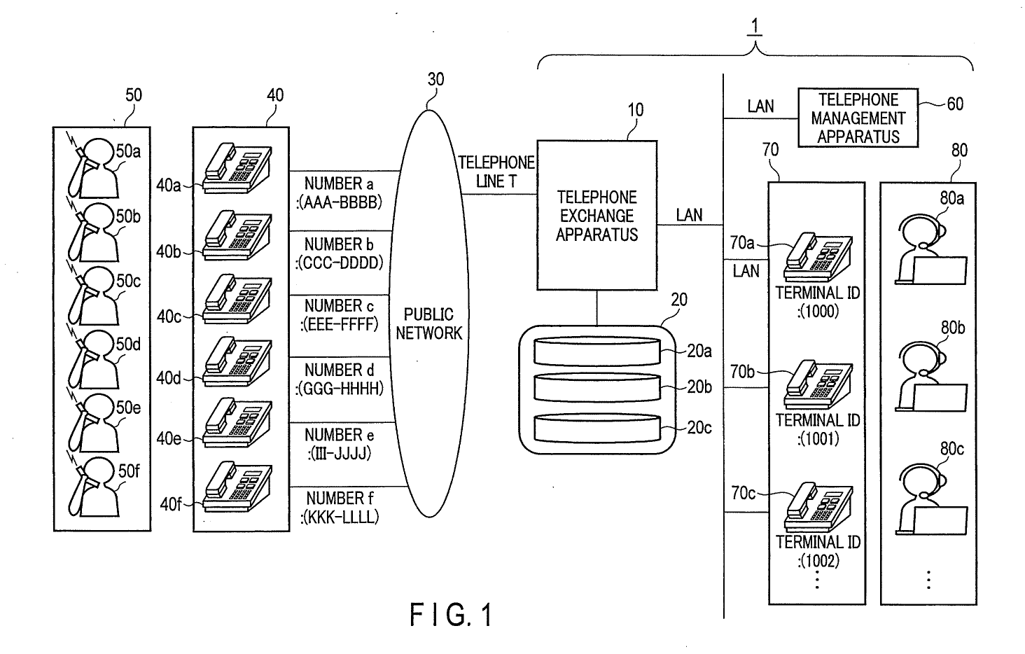

FIG. 1 is a diagram showing an overall configuration example of a call center system comprising a telephone exchange apparatus as a call distribution apparatus of the embodiment.

A call center system 1 comprises, in addition to a telephone exchange apparatus 10 of the embodiment, a priority database 20, a telephone management apparatus 60, and an extension terminal 70 (70a to 70c) used by an operator 80 (80a to 80c).

The telephone exchange apparatus 10 is a type of PBX, and is communicably connected with a call terminal 40 of a customer 50 via a public network 30.

The telephone exchange apparatus 10 is communicably connected with the extension terminal 70 (70a to 70c) used by the operator 80 (80a to 80c) via a LAN (Local Area Network), and also with the telephone management apparatus 60 via the LAN.

The telephone exchange apparatus 10 allocates identification numbers (1000), (1001), and (1002) to the respective extension terminals 70 (70a to 70c).

In addition, telephone numbers (a: (AAA-BBB) to f: (KKK-LLL)) are designated for the respective call terminals 40 (40a to 40f).

In this specification, when the communication terminals 40a to 40f are not distinguished, they are simply referred to as “the communication terminal 40”. Similarly, the extension terminals 70a to 70c and the operators 80a to 80c, when not distinguished, are simply referred to as “the extension terminal 70” and “the operator 80”.

Herein, there are three operators 80 (operators 80a to 80c), but the number is not limited thereto. The operators 80 may be, for example, at least two, and may even be four or more.

The extension terminals 70 (extension terminals 70a to 70c) are not limited to three, and their number may be increased or decreased as with the operators 80. Namely, the number of the extension terminals 70 may be increased or decreased in conjunction with the number of the operators 80.

In addition, there are six customers 50 (customers 50a to 50f), but the number is not limited thereto. The customer 50 may be, for example, at least one.

The communication terminal 40 is also not limited to six (communication terminals 40a to 40f), and its number may be increased or decreased as with the customers 50. Namely, the number of the communication terminals 40 may be increased or decreased in conjunction with the number of customers 50.

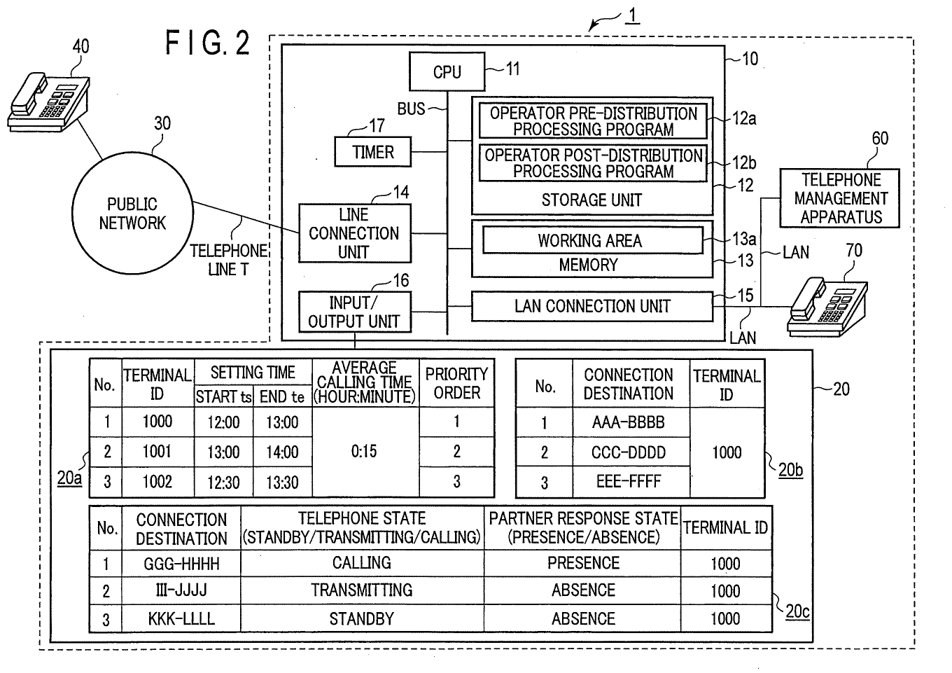

FIG. 2 is a block diagram showing a detailed configuration example of the telephone exchange apparatus 10 and the priority database 20.

The telephone exchange apparatus 10 comprises a control unit 11 (CPU 11), a storage unit 12, a memory 13, a line connection unit 14, a LAN connection unit 15, an input/output unit 16, and a timer 17, which are mutually connected by a system bus (BUS).

The storage unit 12 is formed by a hard disk, a flash memory, etc., and stores an operator pre-distribution processing program 12a and an operator post-distribution processing program 12b.

The storage unit 12 comprises a working area 13a for activating and executing the operator pre-distribution processing program 12a, and the operator post-distribution processing program 12b, by using the CPU 11.

The line connection unit 14 is connected to the public network 30 via a telephone line T.

The LAN connection unit 15 is connected with the telephone management apparatus 60 and the extension terminal 70 via the LAN.

Through such a configuration, the telephone exchange apparatus 10 enables a call between the communication terminal 40 and the extension terminal 70 by using the line connection unit 14 and the LAN connection unit 15 in accordance with control by the CPU 11.

The input/output unit 16 is connected to the priority database 20.

The timer 17 clocks a current time tn.

The priority database 20 comprises a priority order-setting database 20a (storage unit), an operator-setting database 20b (terminal information storage unit), and a connection destination response database 20c (storage unit).

The priority order-setting database 20a stores a record comprising [terminal ID], [designated time] (operation schedule database), [average calling time] (calling time length database), and [priority order] (priority order database).

The [terminal ID] is an identification number of the extension terminal 70 (70a to 70c) used by the operator 80, such as (1000) to (1002), and is stored to correspond to record numbers No. 1 to No. 3.

The [designated time] defines a start time ts and an end time te of a time period when the operator 80 of the extension terminal 70 is unavailable. The unavailable time period corresponds to, for example, a break time (e.g., a lunch break) of the operator 80. At the call center, in order to reduce the time period when the operator 80 is unavailable as greatly as possible in order to improve customer service, break times, such as lunch breaks, are scheduled not en bloc, but individually for each operator 80. In the example shown in FIG. 2, as the [designated time], in the case of [terminal ID]=(1000), [start time ts]=(12:00), and [end time te]=(13:00). This indicates that the break time of the operator 80 who uses [terminal. ID]=(1000) is from 12 a.m. to 1 p.m. Such a [designated time] is registered by each operator 80 in advance.

The [average calling time] is an average calling time tallied up by the telephone management apparatus 60, based on a past call record between the customer 50 and the operator 80, and is (0:15) as an example in FIG. 2. This means 15 minutes.

The [priority order] indicates a priority order of [terminal ID] for connection with the call terminal 40. FIG. 2 shows an example in which, as an initial state, [terminal ID]=(1000) is the first priority, [terminal ID]=(1001) is the second priority, and [terminal ID]=(1002) is the third priority.

The operator-setting database 20b stores a record comprising [connection destination] and [terminal ID].

The [connection destination] represents a telephone number (e.g., AAA-BBBB) of the customer 50, and is stored to correspond to the record numbers No. 1 to No. 3. The [terminal ID] corresponds to [terminal ID] of the first priority in the priority order-setting database 20a. Accordingly, in the example shown in FIG. 2, [terminal ID]=(1000) is set.

The connection destination response database 20c stores a record comprising [connection destination] (connection destination information database), [telephone state], [partner response state] (response presence/absence information database), and [terminal ID].

The [connection destination] represents a telephone number (e.g., GGG-HHHH) of the customer 50, and is stored to correspond to the record numbers No. 1 to No. 3, in the same manner as [connection destination] of the operator-setting database 20b.

The [telephone state] indicates that a state between the call terminal 40 corresponding to [connection destination] and the extension terminal 70 corresponding to [terminal ID] is on standby, during transmission (origination of a call), or during a call. For example, FIG. 2 indicates that the telephone state with [connection destination] (GGG-HHHH) is during a call, the telephone state with [connection destination] (III-JJJJ) is during transmission (origination of a call), and the telephone state with [connection destination] (KKK-LLLL) is on standby.

The [partner response state] indicates presence/absence of a response from the call terminal 40. For example, the record number No. 1 in FIG. 2 indicates that there is a response with respect to a call origination to [connection destination] (GGG-HHHH).

To [terminal ID], [terminal ID]=(1000) of the first priority indicated in [priority order] of the priority order-setting database 20a is set.

An automatic call origination to [connection destination] (GGG-HHHH), (III-JJJJ), and (KKK-LLLL) by the telephone exchange apparatus 10 using the connection destination response database 20c is assumed to count up n (n: a natural number) using the working area 13a, and sequentially originate calls to [connection destination] corresponding to the record number No. 1 when n=1, to [connection destination] corresponding to the record number No. 2 when n=2, and to [connection destination] corresponding to the record number No. 3 when n=3.

Note that the [connection destination] is assumed to be three, but the number of connection destinations is not limited thereto. The [connection destination] may be at least one portion.

In FIGS. 1 and 2, the priority database 20 is provided independently of the telephone exchange apparatus 10, but may be incorporated into the telephone exchange apparatus 10.

The telephone management apparatus 60, for example, calculates an average calling time of each operator 80 with the customer 50 (call terminal 40), based on a past call record between the customer 50 and the operator 80, such as for every constant period of time, and stores the average calling time in [average calling time] of the priority order-setting database 20a.

The telephone exchange apparatus 10 realizes an operator pre-distribution processing function and an operator post-distribution processing function (to be explained below) in the following manner: the CPU 11 controls an operation of each unit of the circuit in accordance with the instructions described in the operator pre-distribution processing program 12a and the operator post-distribution processing program 12b, cooperates with the telephone management apparatus 60, and further uses the information of the priority database 20, thereby causing the software to collaborate with the hardware.

The operator pre-distribution processing function is achieved by activating and executing the operator pre-distribution processing program 12a. The operator pre-distribution processing function updates the priority order of the operator 80 based on the current time to clocked by the timer 17, determines the operator 80 who is available for a call with the customer 50, from among a plurality of operators 80, in accordance with this updated priority order, and then originates a call to the customer 50 (communication terminal 40).

In contrast, the operator post-distribution processing function is achieved by activating and executing the operator post-distribution processing program 12b. The operator post-distribution processing function first originates a call to the customer 50 (communication terminal 40), and if the customer 50 accepts and responds to this call, updates the priority order of the operator 80 based on a response time of the customer 50 clocked by the timer 17. In accordance with this updated priority order, the operator post-distribution processing function determines an operator who is available for a call with the customer 50, from among a plurality of operators 80, and places the operator in charge of the call with the customer 50.

[Operation of Operator Pre-distribution Processing Program 12a]

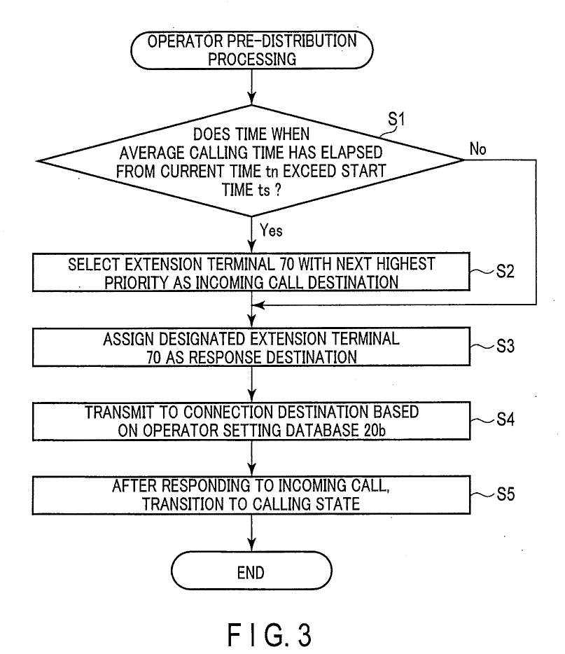

FIG. 3 is a flowchart showing an operation example of the operator pre-distribution processing that can be achieved by activating and executing the operator pre-distribution processing program 12a.

First, each operator 80 registers [start time ts, end time te] as [designated time] of its own in the priority order-setting database 20a by using an input device (not shown, e.g., a keyboard) of the telephone exchange apparatus 10. After that, the operator 80 activates the operator pre-distribution processing program 12a.

Once the operator pre-distribution processing program 12a is activated, the presence/absence of necessity of changing [priority order] in the priority order-setting database 20a is confirmed by the operator pre-distribution processing program 12a. Specifically, it is determined whether or not [terminal ID] in which a time going back by [average calling time] (0:15) from each [start time ts] registered for each operator 80 in advance is a time prior to the current time tn clocked by the timer 17, actually exists (step S1).

In other words, it is determined whether or not [terminal ID] in which a time when [average calling time] (0:15) has passed from the current time tn clocked by the timer 17 exceeds [start time ts] registered for each operator 80 in advance (step S1).

Herein, as an example, a case where the current time tn is 11:50 a.m., and [average calling time] is 15 minutes will be described.

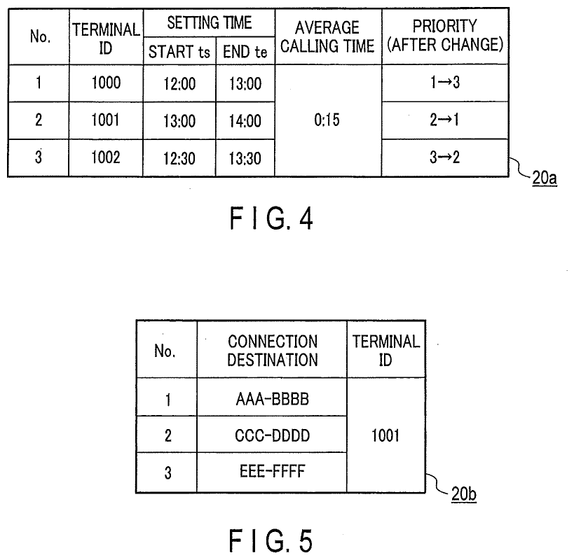

In this case, it is determined that a time when [average calling time] has elapsed from 11:50 a.m. that is the current time tn exceeds 12 a.m. that is [start time ts] of [terminal ID]=(1000) set as the first priority in the priority order-setting database 20a (step S1, YES). In this case, as shown in FIG. 4, the priority order of [terminal ID]=(1001) of the second priority is changed to the first priority in the priority order-setting database 20a (step S2).

FIG. 4 is a conceptual diagram showing the priority order-setting database 20a in which the priority order is updated.

Subsequently, the priority order of [terminal ID]=(1000) of the first priority is changed to the third priority, and the priority order of [terminal ID]=(1002) of the third priority is changed to the second priority.

As shown in the priority order-setting database 20a of FIG. 2 by way of example, since [terminal ID]=(1002) of the record number No. 3 has [start time ts] of 12:30 a.m., [terminal ID]=(1002) has its [start time ts] after that of [terminal ID]=(1000) of the record number No. 1. Since [terminal ID]=(1001) of the record number No. 2 has [start time ts] of 1 p.m., [terminal ID]=(1001) has its [start time ts] a further 30 minutes after the [start time ts] of [terminal ID]=(1002).

For such a reason, [terminal ID]=(1002) is not put on the first priority, but is put on the second priority which is the next priority order, and [terminal ID]=(1001) is put on the first priority.

After that, calls with [connection destination] (AAA-BBBB), (CCC-DDDD), and (EEE-FFFF) are assigned to [terminal ID]=(1001) (step S3). In this way, the operator-setting database 20b updated according to [terminal ID]=(1001) being newly put on the first priority in the priority order-setting database 20a is shown in FIG. 5.

After step S3, as shown in FIG. 5, a call is sequentially and automatically originated to [connection destination] (AAA-BBBB), (CCC-DDDD), and (EEE-FFFF) stored in the operator-setting database 20b (step S4), and a call with the customer 50, who receives and responds to the call among the customers 50 corresponding to a plurality of connection destinations, is connected to the operator 80b corresponding to [terminal ID]=(1000). In this way, a line with the customer 50 is transitioned to a calling state (step S5).

On the other hand, as another example, a case where the current time tn is 11 a.m., and [average calling time] is 15 minutes will be described.

In this case, a time when [average calling time] has elapsed from 11 a.m. that is the current time tn is 11:15 a.m., and does not exceed any [start time ts] (step S1, NO). Thus, the priority order of the priority order-setting database 20a is unchanged, and the transmission operation is continued while maintaining an initial setting.

[Operation of Operator Post-distribution Processing Program 12b]

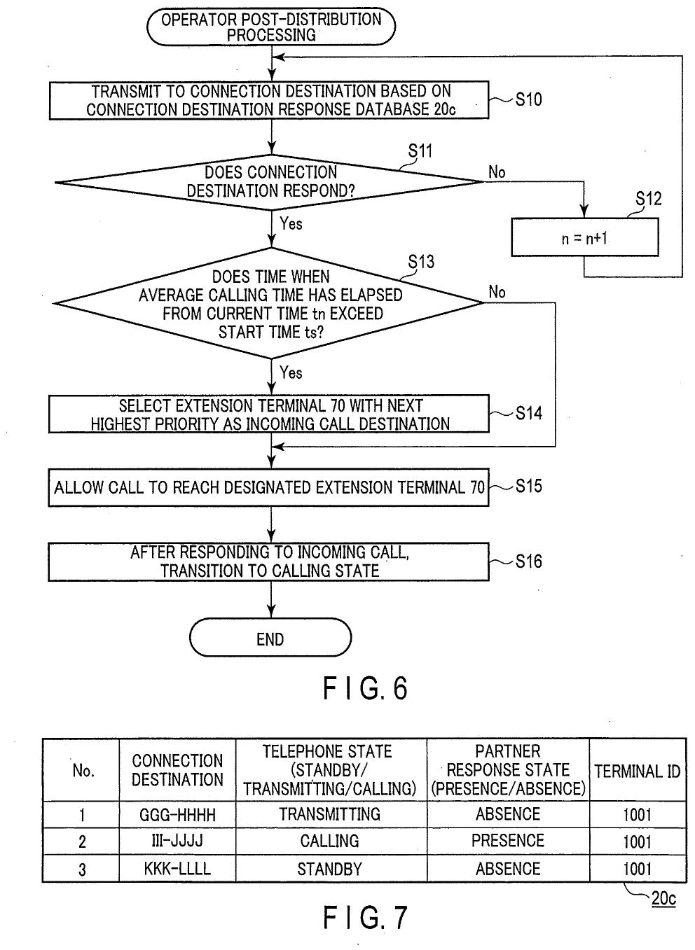

FIG. 6 is a flowchart showing an operation example of operator post-distribution processing achieved by activating and executing the operator post-distribution processing program 12b.

First, each operator 80 registers [start time ts, end time te] as [designated time] of its own in the priority order-setting database 20a by using an input device (not shown, e.g., a keyboard) of the telephone exchange apparatus 10. After that, the operator post-distribution processing program 12b is activated.

Once the operator post-distribution processing program 12b is activated, “1” is substituted for n by using the working area 13a based on [connection destination] (GGG-HHHH), (III-JJJJ), and (KKK-LLLL) of the customer 50, stored in the connection destination response database 20c (shown in FIG. 7) by the operator post-distribution processing program 12b, and a call is automatically originated to [connection destination] (GGG-HHHH) corresponding to the record number No. 1 (step S10).

If the customer 50 of [connection destination] corresponding to the record number No. 1 does not respond (step S11, No), as a result of n being counted up (n+1 is substituted for n), “2” is substituted for n, and a call is automatically originated to [connection destination] (III-JJJJ) corresponding to the record umber No. 2 (step S12→S10). This processing (step S11 (No)→S12→S10) is executed for the number of [connection destination] of the customer 50 stored in the connection destination response database 20c.

Then, if the customer 50 of [connection destination] corresponding to the record number No., 2 receives and responds to the call (step S11, Yes), it is determined whether or not [terminal ID] in which a time going back by [average calling time] (0:15) from each [start time ts] registered for each operator 80 in advance is a time prior to the current time tn (a time when the customer 50 responds) clocked by the timer 17, actually exists (step S13).

In other words, it is determined whether or not [terminal ID] in which a time when [average calling time] (0:15) has elapsed from the current time tn (a time when the customer 50 responds) exceeds [start time ts] registered for each operator 80 in advance, actually exists, in accordance with the current time tn (a time when the customer 50 responds) clocked by the timer 17 (step S13).

Herein also, as an example, the case where the current time tn is 11:50 a.m., and [average calling time] is 15 minutes will be described.

In this case, it is determined that a time when [average calling time] has elapsed from 11:50 a.m. that is the current time tn exceeds 12 a.m. that is [start time ts] of [terminal ID]=(1000) set as the first priority in the priority order-setting database 20a (step S13, Yes).

After that, as shown in FIG. 4, [terminal ID]=(1001) of the second priority is changed to the first priority by the same technique as that of the above-described step S2. In this way, the connection destination response database 20c, updated according to [terminal ID]=(1001) being newly put on the first priority in the priority order-setting database 20a, is shown in FIG. 7.

After step S13, as shown in FIG. 7, [terminal ID]=(1001) is selected as the extension terminal 70 in charge of the call with the customer 50 (step S14).

After that, a call with the responding [connection destination] (III-JJJJ) is connected to the extension terminal 70b corresponding to [terminal ID]=(1001) (step S15). Thereby, the line with the customer 50 is transitioned to a calling state (step S16).

On the other hand, as another example, a case where the current time tn is 11 a.m., and the [average calling time] is 15 minutes will be described.

In this case, a time when [average calling time] has elapsed from 11 a.m. that is the current time tn is 11:15 a.m., and does not exceed any [start time ts] shown in the priority order-setting database 20a (step S13, No). Thus, the priority order of the priority order-setting database 20a is unchanged, and the transmission operation is continued while maintaining the initial setting (step S15→S16).

Thus, according to the telephone exchange apparatus 10 of the embodiment, if it is determined that a time when [average calling time] has elapsed from the current time tn exceeds [start time ts] registered for each operator 80 in advance and stored in the priority order-setting database 20a, the priority order is updated by setting the priority order of [terminal ID] corresponding to [start time ts] closest to the current time tn to the lowest, and raising the priority order of another [terminal ID]. The customer handling is then assigned to [terminal ID] with the highest priority order after update, in order to execute the transmission operation.

In addition, according to the telephone exchange apparatus 10 of the embodiment, by performing the transmission operation based on [connection destination] stored in the connection destination response database 20c, in the case where the customer 50 receives and responds to the call, and if it is determined that [terminal ID] in which a time when [average calling time] has elapsed from the current time tn (a time when the customer 50 responds) exceeds [start time ts] registered for each operator 80 in advance and stored in the priority order-setting database 20a, actually exists, the priority order is updated by setting the priority order of [terminal ID] corresponding to [start time ts] closest to the current time tn to the lowest and raising the priority order of another [terminal ID]. The customer handling is then assigned to [terminal ID] with the highest priority after update to execute the transmission operation.

In this way, [priority order] of [terminal ID] is automatically updated if it is determined that a time when [average calling time] has elapsed from the current time tn exceeds the preregistered [start time ts].

Specifically, [terminal ID] with more sufficient time from the current time tn to [start time ts] is assigned as a destination of an incoming call from the customer 50, and the transmission operation is transferred. Accordingly, as shown in the example of FIG. 2, distribution by the telephone exchange apparatus 10 will not be performed with respect to [terminal ID] (1000), which was previously the first priority. Thus, it becomes possible to assign the transmission operation without causing inconvenience to the operator 80 corresponding to [terminal ID] (1000).

The above-described operator pre-distribution processing (step S1 to step S5) is executed whenever necessary. Namely, in the second operator pre-distribution processing, if it is determined that a time when [average calling time] has elapsed from the current time to exceeds [start time ts] registered for each operator 80 in advance and stored in the priority order-setting database 20a, [priority order] stored in the priority order-setting database 20a is updated again, and the transmission operation is assigned to [terminal ID] which is the next [priority order] (e.g., the second priority).

In the priority order-setting database 20a in the above-described embodiment, [terminal ID], [designated time], [average calling time], and [priority order] are corresponded and stored, but the configuration is not limited thereto. For example, information related to the operator 80 (80a to 80c) may be used instead of [terminal ID].

While certain embodiments have been described, these embodiments have been presented by way of example only, and are not intended to limit the scope of the invention. These embodiments may be realized in various other forms, and various omissions, replacements, and changes can be made without departing from the gist of the invention. The accompanying claims and their equivalents are intended to cover such forms or modifications as would fall within the scope and spirit of the invention.

1. A call distribution apparatus performing a call distribution with respect to an operator, comprising:
a storage unit, including an operation schedule database which stores an operation schedule of the operator and a calling time length database which stores a calling time length of the operator; and
an operator determination unit which determines an operator to be assigned, based on the operation schedule and the calling time length.

2. The call distribution apparatus according to claim 1, wherein the operator determination unit further determines the operator to be assigned based on a priority order of the operator.

3. The call distribution apparatus according to claim 1, further comprising a terminal information storage unit which stores connection destination information of a called terminal and identification information of a terminal used by the operator,
wherein a line connection between the called terminal and the terminal used by the operator is performed, based on the connection destination information and the identification information of the terminal used by the operator.

4. The call distribution apparatus according to claim 2,
wherein the storage unit further comprises a priority order database in which the priority order of the operator is stored,
wherein the storage unit stores, as the calling time length, an average calling time determined from a past call record between a called terminal and the operator, and
wherein the operation schedule includes a start time and an end time of a time period when the operator is unavailable.

5. The call distribution apparatus according to claim 4, further comprising a determination unit which determines, when a line with the called terminal is connected to the operator determined by the operator determination unit based on the priority order, whether or not the operator with the operation schedule in which a time when the average calling time has elapsed from a current time exceeds a start time of the time period when the operator is unavailable, exists, based on the operation schedule database,
wherein, if such an operator exists, a line with the called terminal is connected to the operator not including the operation schedule that exceeds the start time, in accordance with the priority order of the operator.

6. A call distribution apparatus which assigns a call with a called terminal to an operator when the called terminal receives the call with respect to a call origination, the call distribution apparatus comprising:
a storage unit which stores an operation schedule database storing an operation schedule of the operator; and
an operator determination unit which determines an operator to be assigned, based on the operation schedule and a time when a call is received by the called terminal.

7. The call distribution apparatus according to claim 6,
wherein the storage unit further comprises:
a connection destination information database which stores connection destination information of the called terminal necessary for connecting a line with the called terminal; and
a response presence/absence information database which stores response presence/absence information related to presence/absence of a response of the called terminal with respect to a call origination to the called terminal,
wherein, if a line with the called terminal is connected to the operator determined by the operator determination unit, a call is originated to the called terminal based on the connection destination information stored in the storage unit, and the line connection is performed when the call is received by the called terminal in response to the call origination.

8. A call distribution method in which a call distribution with respect to an operator is executed by a processor,
wherein the processor determines an operator to be assigned, based on an operation schedule of the operator stored in an operation schedule database and a calling time length of the operator stored in a calling time length database.

9. A call distribution method in which, when a called terminal receives a call with respect to a call origination, a processor executes a call distribution with the called terminal with respect to an operator,
wherein the processor determines an operator to be assigned, based on an operation schedule of the operator stored in an operation schedule database and a time when the call is received by the called terminal.

10. A program for causing a processor to execute a call distribution with respect to an operator, the program causing the processor to execute
a determination procedure of determining an operator to be assigned, based on an operation schedule of the operator stored in an operation schedule database and a calling time length of the operator stored in a calling time length database.

11. A program for causing a processor to execute a call distribution with a called terminal to an operator when the called terminal receives the call with respect to a call origination, the program causing the processor to execute
a determination procedure of determining an operator to be assigned, based on an operation schedule of the operator stored in an operation schedule database and a time when the call is received by the called terminal.
